(19) United States
(12) Patent Application Publication
(10) Pub. No.: US 2026/0042418 A1
(43) Pub. Date: Feb. 12, 2026

(54) Handle System and Control Method for Vehicle and Vehicle

(71) Applicant: Illinois Tool Works Inc., Glenview, IL (US)

(72) Inventor: Kangxi Ning, Shanghai (CN)

(21) Appl. No.: 19/291,143

(22) Filed: Aug. 5, 2025

(30) Foreign Application Priority Data
Aug. 6, 2024 (CN) 2024110701800
Jul. 29, 2025 (CN) 2025110497235

(51) Int. Cl. B60R 25/01; B60R 25/24; B60R 25/31; E05B 85/10

(52) U.S. Cl. CPC B60R 25/01; B60R 25/245; B60R 25/31; E05B 85/107

(57) ABSTRACT

A handle system and control method for a vehicle are provided. The system includes a handle that can move between a deployed (extended) position and a retracted position, with an ultrasonic sensor mounted on the handle to detect foreign objects in a designated receiving area. An actuator controls the movement of the handle. If the sensor detects an object in the receiving area while the handle is retracting, the system either stops the handle from retracting or returns it to the deployed position to prevent obstruction or damage.

### RELATED APPLICATIONS

The present application claims the benefit of Chinese Patent Application Nos. 2024110701800, filed Aug. 6, 2024, and CN 2025110497235, filed Jul. 29, 2025, each titled “Handle System and Control Method for Vehicle and Vehicle,” the contents of which are hereby incorporated by reference.

### TECHNICAL FIELD

The present disclosure relates to a handle system, and in particular to a handle system for a vehicle, a control method for a vehicle, and a vehicle.

### BACKGROUND

A handle system of a vehicle, for example, an exterior flush door handle assembly, is designed to have a handle that can be grasped by an operator to open a vehicle door, or to unlock the vehicle door, etc. For this purpose, the handle of the handle system of the vehicle can protrude beyond a vehicle door surface, such that the operator can grasp the handle to perform the above operations.

### SUMMARY

The present disclosure relates generally to a handle system, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is an illustrative view of a vehicle having a handle system according to an embodiment of the present disclosure.

FIG. 1B is a top view of the handle system in FIG. 1A when a handle of the handle system is in a retracted position.

FIG. 1C is a top view of the handle system in FIG. 1A when the handle of the handle system in a deployed position.

FIG. 2 is a structural block diagram of the handle system in FIG. 1A.

FIG. 3 is a block diagram of a control flow of a control unit according to an embodiment of the present disclosure.

FIG. 4 is a block diagram of a control flow of the control unit according to another embodiment of the present disclosure.

FIG. 5 is a block diagram of a control flow of the control unit according to yet another embodiment of the present disclosure.

FIG. 6 is a structural block diagram of an embodiment of the control unit.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

According to a first aspect of the present disclosure, the present disclosure provides a handle system for a vehicle. The handle system comprises a handle seat; a handle having a retracted position and a deployed position and having a receiving area; an ultrasonic sensor disposed on the handle and configured to detect whether there is a foreign object or not in the receiving area; and an actuating device configured to drive the handle to move between the deployed position and the retracted position. The actuating device is configured to, in response to the ultrasonic sensor detecting the presence of the foreign object in the receiving area during movement of the handle from the deployed position toward the retracted position, stop driving the handle toward the retracted position or drive the handle to the deployed position.

According to some embodiments of the present disclosure, the handle system further comprises a control unit communicatively connected to the ultrasonic sensor and the actuating device to control the actuating device according to a detection signal of the ultrasonic sensor.

According to some embodiments of the present disclosure, the control unit is configured to drive the handle to the deployed position when the vehicle has not been driven and a vehicle owner has been identified, and to unlock an electronic lock device of the vehicle in response to the ultrasonic sensor detecting the presence of the foreign object in the receiving area after the handle reaches the deployed position.

According to some embodiments of the present disclosure, the handle has an inner surface defining the receiving area and has a receiving hole running through the inner surface, and the ultrasonic sensor is received in the receiving hole and exposed to the receiving area.

According to some embodiments of the present disclosure, the ultrasonic sensor has an outer surface facing the receiving area, the outer surface being flush with at least a part of the inner surface of the receiving area adjacent to the receiving hole.

According to some embodiments of the present disclosure, the handle comprises two opposite longitudinal extensions and two opposite transverse extensions surrounding the receiving area. The ultrasonic sensor is disposed in one of the two transverse extensions, or one of the two longitudinal extensions.

According to a second aspect of the present disclosure, the present disclosure provides a control method for controlling a vehicle comprising a handle system. The control method comprises the steps of (i) actuating an ultrasonic sensor to perform detection of a receiving area of a handle; (ii) determining whether there is a foreign object in the receiving area of the handle based on a detection signal received from the ultrasonic sensor during movement of the handle toward the retracted position; and (iii) stop driving the handle to move toward the retracted position or driving the handle to a deployed position if it is determined in step (ii) that there is a foreign object in the receiving area of the handle.

According to some embodiments of the present disclosure, the control method further comprises (a) driving the handle to the deployed position when the vehicle has not been driven and a vehicle owner has been identified; (b) determining whether there is a foreign object in the receiving area of the handle based on the detection signal received from the ultrasonic sensor after the handle reaches the deployed position; and (c) unlocking an electronic lock device of the vehicle if it is determined in step (b) that there is a foreign object in the receiving area of the handle.

According to some embodiments of the present disclosure, the control method further comprises driving the handle to move toward the retracted position and performing the above steps (ii)-(iii) during movement of the handle toward the retracted position if it is determined in step (b) that there is no foreign object in the receiving area of the handle.

According to some embodiments of the present disclosure, the control method further comprises driving the handle to move toward the retracted position and performing the above steps (ii)-(iii) during movement of the handle toward the retracted position after the electronic lock device of the vehicle is locked.

According to some embodiments of the present disclosure, the control method further comprises driving the handle to move toward the retracted position and performing the above steps (ii)-(iii) during movement of the handle toward the retracted position when the vehicle has been driven to move and the handle is in the deployed position.

According a third aspect of the present disclosure, the present disclosure provides a vehicle comprising a handle system or control method according to the present disclosure.

The present disclosure employs an ultrasonic sensor which generates a detection signal without requiring an operate to touch the ultrasonic sensor, thereby achieve an active “anti-pinch” function.

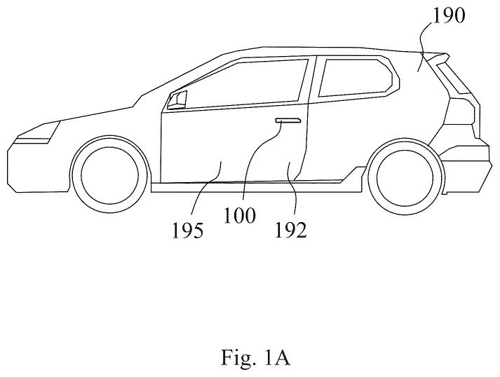

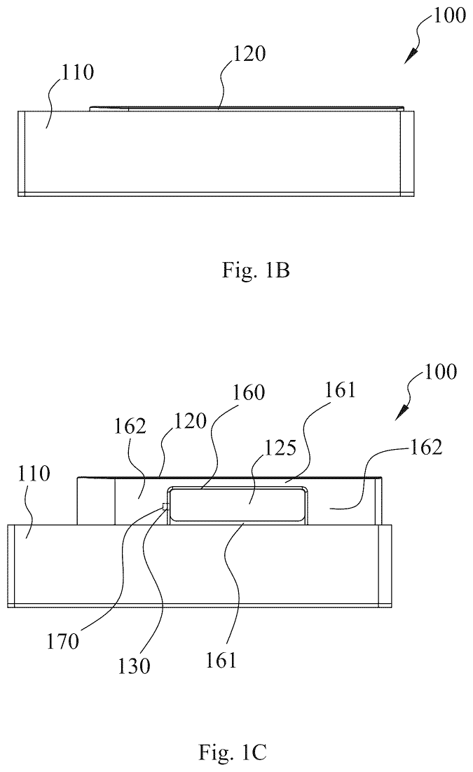

FIGS. 1A-1C illustrate a use environment and an operating state of a handle system 100 according to an embodiment of the present disclosure. FIG. 1A is an illustrative view of a vehicle 190 having the handle system 100, FIG. 1B is a top view of the handle system 100 when a handle 120 of the handle system 100 is in a retracted position, and FIG. 1C is a top view of the handle system 100 when the handle 120 of the handle system 100 is in a deployed position.

As shown in FIGS. 1A-1C, the handle system 100 is a flush handle system, which is mounted on a door 192 of the vehicle 190 to open the door 192 and to unlock the door 192. The handle system 100 includes a handle seat 110 and the handle 120. The handle 120 is mounted on the handle seat 110 and is movable relative to the handle seat 110 so as to have the retracted position as shown in FIG. 1B and the deployed position as shown in FIG. 1C. When the handle 120 is in the retracted position, the handle 120 is flush with an outer surface 195 of the door 192 of the vehicle 190. Thus, the handle 120 is hidden in the door 192, and an operator cannot pull the handle 120. When the handle 120 is in the deployed position, the handle 120 protrudes outwardly relative to the outer surface 195 of the door 192, allowing the operator to pull the handle 120. In other embodiments, the handle system according to an embodiment of the present disclosure may also be used in a case where the door is opened from the inside of the door, and the handle thereof is flush with an inner surface of the door when in the retracted position.

As shown in FIG. 1B, the handle system 100 further includes an ultrasonic sensor 130 disposed on the handle 120. The handle 120 includes two opposite longitudinal extensions 161 and two opposite transverse extensions 162, and the respective inner surfaces of the longitudinal extensions 161 and the transverse extensions 162 collectively form an inner surface 160 of the handle that defines a receiving area 125. The operator can place his/her hand into the receiving area 125 to grasp the handle 120 and pull the door 192. The ultrasonic sensor 130 is disposed on one of the two transverse extensions 162 and configured to detect a foreign object entering into the receiving area 125. Specifically, one of the transverse extensions 162 is formed with a receiving hole 170 running through the inner surface 160. The ultrasonic sensor 130 is accommodated in the receiving hole 170 and is flush with the inner surface 160 at the transverse extension 162. In other embodiments, the ultrasonic sensor 130 may be disposed at other positions of the handle 120, such as the longitudinal extension 161, etc., as long as the ultrasonic sensor 130 can detect the foreign object in the receiving area 125. When the ultrasonic sensor 130 detects that there is a foreign object (e.g., a human hand, a manicure on the human hand, other foreign objects, and so on) entering into the receiving area 125, the ultrasonic sensor 130 can generate a corresponding detection signal.

As a non-contact measurement sensor, the ultrasonic sensor 130 can reduce wear and prolong the service life. Moreover, the ultrasonic sensor 130 has the characteristics of high precision, strong anti-interference capability, fast response, etc., and therefore it can actively detect the presence of the foreign object in the receiving area 125 in real time and generate a corresponding detection signal in real time.

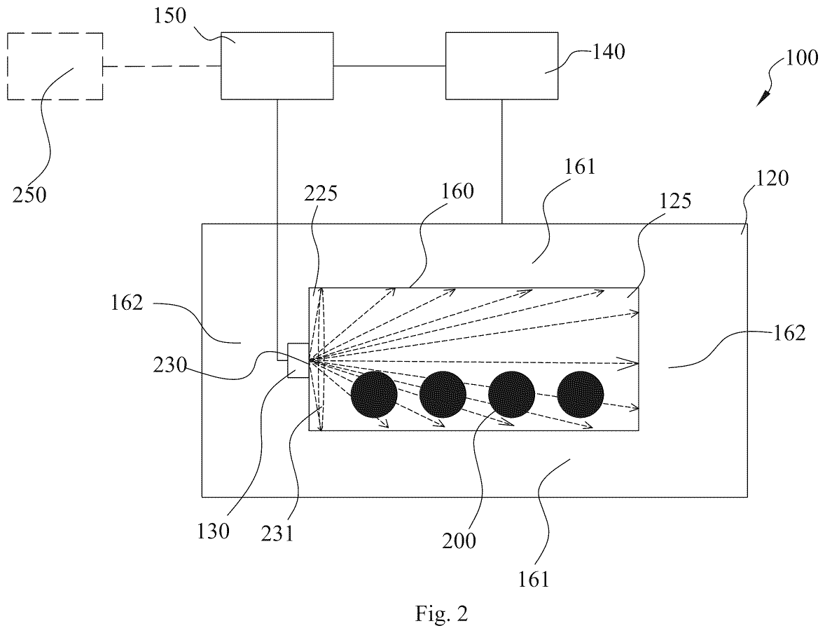

FIG. 2 is a structural block diagram of the handle system 100, which shows a schematic view of components of the handle system 100 and a connection relationship of the components. As shown in FIG. 2, in addition to the handle 120, the handle system 100 further includes an actuating device 140 and a control unit 150. The actuating device 140 is, for example, an actuator including a motor, and is configured to drive the handle 120 to move between the deployed position and the retracted position. The control unit 150 is communicatively connected to the ultrasonic sensor 130 and the actuating device 140. The control unit 150 can receive the detection signal input by the ultrasonic sensor 130 and output a control signal to the actuating device 140 to control the operation of the actuating device 140 in response to the detection signal. In an embodiment shown in FIG. 2, the control unit 150 is a part of the handle system 100, but in other embodiments, the control unit 150 may also be a central control unit of the vehicle. The control unit 150 is further communicatively connected to an electronic lock device 250 of the vehicle to control the unlocking and locking of the electronic lock device 250 of the vehicle.

In some embodiments, the ultrasonic sensor 130 enables the handle to obtain an “anti-pinch” function. Specifically, during the movement of the handle 120 from the deployed position to the retracted position, the ultrasonic sensor 130 detects whether there is a foreign object 200 or not in the receiving area 125. The ultrasonic sensor 130 sends the corresponding detection signal to the control unit 150 when detecting the foreign object 200. In response to the detection signal from the ultrasonic sensor 130, the control unit 150 sends to the actuating device 140 a control signal indicating stopping the movement to stop the handle 120 from moving toward the retracted position, or sends a control signal indicating deploying to reversely move the handle 120 to the deployed position. Thus, the handle system 100 achieves the “anti-pinch” function by the ultrasonic sensor 130 actively detecting whether there is a foreign object or not in the receiving area 125 of the handle.

Since the ultrasonic sensor is used in the present disclosure, the detection signal is generated without requiring the operator to come into contact with the ultrasonic sensor. Therefore, the “anti-pinch” function of the present disclosure is active pinch prevention, but is not trigged by an actual or impending pinching event (e.g., a capacitive sensor requires physical contact to generate a detection signal), and thus eliminates the operator's worry about hand pinching.

As shown in FIG. 2, in some embodiments, the ultrasonic sensor 130 is disposed on the transverse extension 162 on the left side and emits detection waves into the receiving area 125 from the left to the right. The detection waves form a tapered detection area 231. Therefore, the ultrasonic sensor 130 can detect the foreign object 200 entering the detection area 231, and the area outside the detection area 231 in the receiving area 125 is a detection blind area 225.

In some embodiments, a maximum detection angle range of the ultrasonic sensor 130 is set to 140°-160°, that is, an included angle of the tapered detection area 231 is 140°-160°. The above maximum detection angle range limits a maximum distance of the detection blind area 225 in a longitudinal direction (i.e., left and right directions in FIG. 2) to be less than a predetermined value, for example, 4 mm. Thus, it is ensured that the ultrasonic sensor 130 can detect all objects having a diameter greater than the predetermined value. Therefore, the detection blind area is reduced to the greatest extent. The right end of the ultrasonic sensor 130 is exposed to the receiving area 125, and an outer surface 230 of the ultrasonic sensor is flush with the inner surface 160 of the left transverse extension 162 of the handle 120, which thus facilitates the detection of the ultrasonic sensor 130. This is because if the outer surface 230 of the ultrasonic sensor 130 is obscured or covered by the inner surface 160 of the handle, the handle 120 blocks the ultrasonic sensor 130 and decreases the detection angle of the ultrasonic sensor 130, resulting in an increase of the detection blind area 225. If the outer surface 230 protrudes beyond the inner surface 160, the foreign object 200 may mistakenly come into contact with the ultrasonic sensor 130 to shorten the service life of the ultrasonic sensor 130, and the blind detection blind area 225 increases. Furthermore, since the outer surface 230 of the ultrasonic sensor 130 is flush with the inner surface 160 of the handle 120 around the ultrasonic sensor 130, the aesthetic appearance of a visible area of the handle 120 is improved and the touch feel when gripping the handle is not affected.

In addition, in some embodiments, a color of the outer surface of a part of the ultrasonic sensor 130 exposed to the receiving area 125 is consistent with a color of the inner surface of the handle 120, such that the aesthetic appearance is improved.

As still shown in FIG. 2, the ultrasonic sensor 130 can also be configured to determine whether the electronic lock device 250 of the vehicle is allowed to be unlocked or not. Specifically, when the vehicle 190 is in an undriven state and the handle is in the deployed position, it is indicated that the operator has an intention to open the vehicle door if the ultrasonic sensor 130 detects that there is a foreign object 200 (e.g., a human hand or a manicure on the human hand) entering into the receiving area 125. When the ultrasonic sensor 130 detects that there is a foreign object 200 in the receiving area 125, the corresponding detection signal is generated and sent to the control unit 150. The control unit 150 unlocks the electronic lock device 250 in response to the detection signal, and thus the operator can open the vehicle door.

As described above, by using only this single detection element, i.e., the ultrasonic sensor 130, at least two functions including unlocking the electronic lock device of the vehicle 190 and active “anti-pinch” of the handle are achieved. That is to say, there is no need to provide other sensors or activation devices to unlock the electronic lock device of the vehicle 190, and accordingly the handle system has simplified components and control flow.

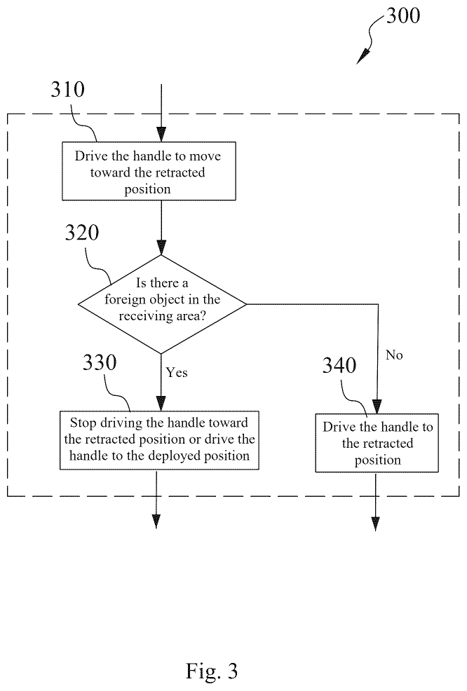

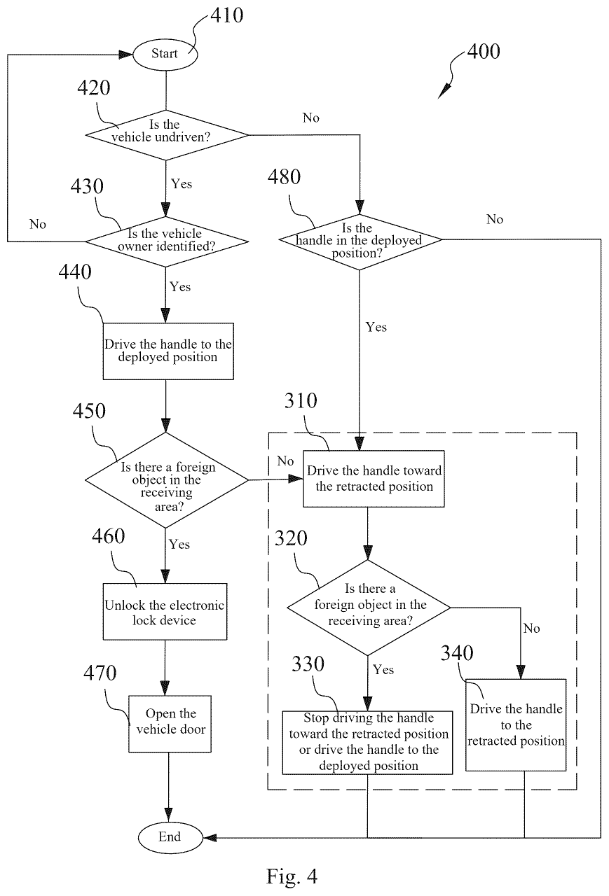

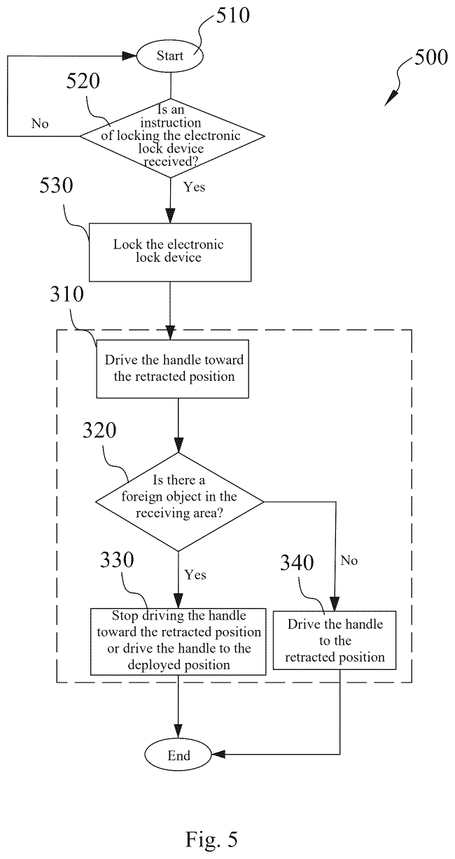

FIG. 3 is a block diagram of a control flow 300 of the control unit 150 according to an embodiment of the present disclosure, which is a part of a sub-flow of the control unit 150 in performing some functions (e.g., the functions shown in FIGS. 4 and 5).

As shown in FIG. 3, the control flow 300 starts during movement of the handle 120 toward the retracted position. The control flow 300 comprises steps 320, 330 and 340. In step 320, the control unit 150 determines whether there is a foreign object 200 or not in the receiving area 125 according to the signal received from the ultrasonic sensor 130. If yes, the control flow 300 goes to step 330, and if not, the control flow 300 goes to step 340. In step 330, the control unit 150 sends a signal to the actuating device 140 to stop driving the handle 120 to move toward the retracted position by the actuating device 140 or to drive the handle 120 to the deployed position by the actuating device 140. In step 340, the control unit 150 sends a signal to the actuating device 140 to drive the handle 120 to continue to move to the retracted position by the actuating device 140.

In some embodiments, in step 320, the control unit 150 first actuates the ultrasonic sensor 130 to perform detection of the receiving area 125 of the handle 120, and then determines whether there is a foreign object 200 or not in the receiving area 125 based on the signal received from the ultrasonic sensor 130. In some other embodiments, the control unit 150 may actuate the ultrasonic sensor 130 to perform detection of the receiving area 125 of the handle 120 before step 320, for example at the time that the control unit 150 starts working.

According to the flow shown in FIG. 3, the above-described steps are performed during the whole movement of the handle 120 toward the retracted position to actively determine whether there is a foreign object or not in the receiving area 125 such that the handle 120 has the “anti-pinch” function.

FIG. 4 is a block diagram of a control flow 400 of the control unit 150 according to another embodiment of the present disclosure, which is used to deploy the handle and unlock the electronic lock device before the vehicle is driven to move.

As shown in FIG. 4, in step 410, the control unit 150 starts to work. In step 420, the control unit 150 determines whether the vehicle 190 is in the undriven state or not. If yes, the control flow goes to step 430, and if not, the control flow goes to step 480. The control unit determines whether the vehicle 190 is in the undriven state or not by receiving information of a vehicle speed of the vehicle 190. If the vehicle speed is zero, the control unit determines that the vehicle 190 is in the undriven state, and if the vehicle speed is not zero, the control unit determines that the vehicle 190 is in a driven state.

In step 430, the control unit 150 determines whether the operator is the vehicle owner or not on the basis of identity information of the vehicle owner. If not, the control flow returns to step 410, and if yes, the control flow goes to step 440. Methods for identifying the vehicle owner include any one of the following means: a conventional key, a smart key, Bluetooth, a mobile application, a biological feature, NFC, and so on.

In step 440, the control unit 150 sends a signal to the actuating device 140 to drive the handle 120 to reach the deployed position by the actuating device 140. Then, the control flow goes to step 450.

In step 450, the control unit 150 determines whether there is a foreign object 200 or not in the receiving area 125. If yes, the control flow goes to step 460, and if not, the control flow goes to step 490. In some embodiments, in step 450, the control unit 150 first actuates the ultrasonic sensor 130 to perform detection of the receiving are 125 of the handle 120, and then determines whether there is a foreign object 200 or not in the receiving area 125 based on the signal received from the ultrasonic sensor 130. In some other embodiments, the control unit 150 may actuate the ultrasonic sensor 130 to perform detection of the receiving area 125 of the handle 120 before step 450, for example at the time when the control unit 150 starts working.

In step 490, the control unit 150 sends a signal to the actuating device 140 to drive the handle to move toward the retracted position by the actuating device 140. Thereafter, step 320 and its subsequent steps 330 and 340 (i.e., the sub-flow 300 shown in FIG. 3) are performed during the movement of the handle 120 toward to the retracted position. In some embodiments, a preset period of time is set between step 450 and step 490, and the control flow does not go from step 450 to step 490 unless the preset period of time has elapsed.

In step 460, the control unit 150 sends an unlocking signal to the electronic lock device 250 to unlock the electronic lock device 250, and then the control flow goes to step 470.

In step 470, the control unit 150 opens the vehicle door and ends the flow. In step 470, the control unit can control the vehicle door to be popped open and electrically opened. Of course, if the vehicle does not have the functions of automatically pop-opening the vehicle door and electrically opening the vehicle door, step 470 may be omitted.

In step 480, the control unit 150 identifies whether the handle 120 is in the deployed position or not. If yes, the control flow goes to the step 490 and its subsequent steps (i.e., the sub-flow 300 shown in FIG. 3), and if not, the control flow ends.

Thus, according to the flow shown in FIG. 4, the present disclosure provides a control method for a vehicle, which is used to deploy the handle and unlock the electronic lock device before the vehicle is driven to move. Furthermore, the control method also enables the handle to retract with taking into account the situation that the vehicle may has been driven to move but the handle has not been retracted, so as to improve the safety performance of the vehicle.

FIG. 5 is a block diagram of a control flow 500 of the control unit 150 according to another embodiment of the present disclosure, which is used to retract the handle after the electronic lock device of the vehicle is locked.

As shown in FIG. 5, in step 510, the control unit 150 starts to work. In step 520, the control unit 150 makes a determination based on whether an instruction of locking the electronic lock device 250 is received or not. If yes, the control flow goes to step 530, and if not, the control flow returns to step 510.

In step 530, the control unit 150 controls the locking of the electronic lock device 250, and then the control flow goes to the step 540.

In step 540, the control unit 150 sends a signal to the actuating device 140 to drive the handle 120 to move toward the retracted position by the actuating device 140. Thereafter, the step 320 and its subsequent steps 330 and 340 (i.e., the sub-flow 300 shown in FIG. 3) are performed during the movement of the handle 120 toward to the retracted position, and all the flow finally completes.

Thus, according to the flow shown in FIG. 5, the present disclosure provides a control method for a vehicle, which is used to retract the handle after the electronic lock device of the vehicle is locked.

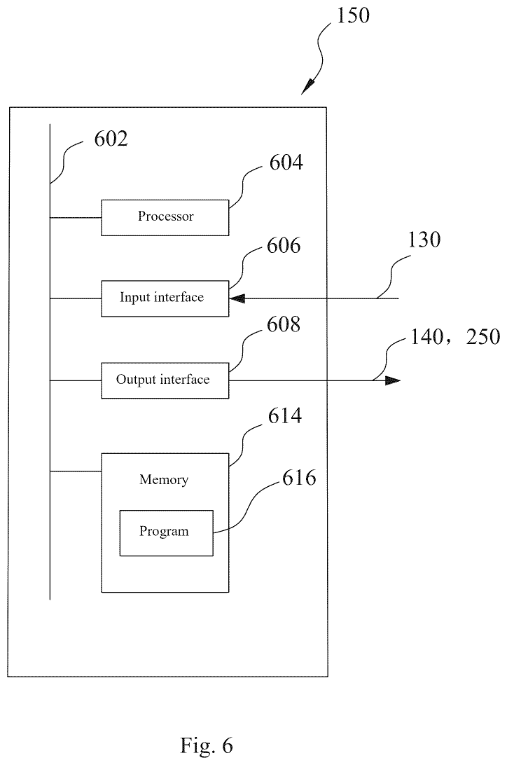

FIG. 6 is a structural block diagram of an embodiment of the control unit 150. As shown in FIG. 6, the control unit 150 includes a bus 602, a processor 604, an input interface 606, an output interface 608 and a memory 614 storing programs 616. Each of the processor 604, the input interface 606, the output interface 608 and the memory 614 is communicatively connected to the bus 602, such that the processor 604 can control the operation of the input interface 606, the output interface 608 and the memory 614. The memory 614 is configured to store programs, instructions and data. The processor 604 reads the programs, the instructions and the data from the memory 614, and can write data to the memory 614. The programs 616 include programs for implementing the control flows shown in FIGS. 3-5. The input interface 606 is connected to the ultrasonic sensor 130 to obtain a signal indicating whether a foreign object 200 is present in the receiving area 125, and also receives instructions or information input, such as locking of an electronic lock, identification of the vehicle owner, and so on. The output interface 608 is connected to the actuating device 140 and the electronic lock device 250 to send control signals to the actuating device 140 and the electronic lock device 250, so as to control the deployment or retraction of the handle 120 and to control the unlocking and locking of the electronic lock device of the vehicle.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### REFERENCE NUMERALS

Handle system 100
Handle seat 110
Handle 120
Receiving area 125
Ultrasonic sensor 130
Actuating device 140
Control unit 150
Inner surface 160
Longitudinal extension 161
Transverse extension 162
Receiving hole 170
Vehicle 190
Door 192
Outer surface 195 (of door)
Electronic lock device 250
Foreign object 200
Outer surface 230 (of ultrasonic sensor)
Detection area 231
Detection blind area 225
Electronic lock device 250
Bus 602
Processor 604
Input interface 606
Output interface 608
Memory 614
Program 616

What is claimed is:

1. A handle system for a vehicle, the handle system comprising:
a handle seat;
a handle having a retracted position and a deployed position and having a receiving area;
an ultrasonic sensor disposed on the handle and configured to detect whether there is a foreign object or not in the receiving area; and
an actuating device configured to drive the handle to move between the deployed position and the retracted position;
wherein the actuating device is configured to, in response to the ultrasonic sensor detecting a presence of the foreign object in the receiving area during movement of the handle from the deployed position toward the retracted position, stop driving the handle toward the retracted position or drive the handle to the deployed position.

2. The handle system according to claim 1, further comprising:
a control unit communicatively connected to the ultrasonic sensor and the actuating device to control the actuating device according to a detection signal of the ultrasonic sensor.

3. The handle system according to claim 2, wherein
the control unit is configured to drive the handle to the deployed position when the vehicle has not been driven and a vehicle owner has been identified, and to unlock an electronic lock device of the vehicle in response to the ultrasonic sensor detecting the presence of the foreign object in the receiving area after the handle reaches the deployed position.

4. The handle system according to claim 1, wherein
the handle has an inner surface defining the receiving area and has a receiving hole running through the inner surface, and the ultrasonic sensor is received in the receiving hole and exposed to the receiving area.

5. The handle system according to claim 4, wherein
the ultrasonic sensor has an outer surface facing the receiving area, the outer surface being flush with at least a part of the inner surface of the receiving area adjacent to the receiving hole.

6. The handle system according to claim 5, wherein
the handle comprises two opposite longitudinal extensions and two opposite transverse extensions surrounding the receiving area;
wherein the ultrasonic sensor is disposed in one of the two transverse extensions, or one of the two longitudinal extensions.

7. A control method for controlling a vehicle comprising a handle system, the control method comprising the steps of:
(i) actuating an ultrasonic sensor to perform detection of a receiving area of a handle;
(ii) determining whether there is a foreign object in the receiving area of the handle based on a detection signal received from the ultrasonic sensor during movement of the handle toward a retracted position; and
(iii) stop driving the handle to move toward the retracted position or driving the handle to a deployed position if it is determined in step (ii) that there is a foreign object in the receiving area of the handle.

8. The control method according to claim 7, further comprising:
(a) driving the handle to the deployed position when the vehicle has not been driven and a vehicle owner has been identified;
(b) determining whether there is a foreign object in the receiving area of the handle based on the detection signal received from the ultrasonic sensor after the handle reaches the deployed position; and
(c) unlocking an electronic lock device of the vehicle if it is determined in step (b) that there is a foreign object in the receiving area of the handle.

9. The control method according to claim 8, further comprising:
driving the handle to move toward the retracted position and performing the above steps (ii)-(iii) during movement of the handle toward the retracted position if it is determined in step (b) that there is no foreign object in the receiving area of the handle.

10. The control method according to claim 8, further comprising:
driving the handle to move toward the retracted position and performing the above steps (ii)-(iii) during movement of the handle toward the retracted position after the electronic lock device of the vehicle is locked.

11. The control method according to claim 7, further comprising:
driving the handle to move toward the retracted position and performing the above steps (ii)-(iii) during movement of the handle toward the retracted position when the vehicle has been driven to move and the handle is in the deployed position.

12. A vehicle comprising the handle system according to claim 1.

13. A vehicle comprising the control method according to claim 7.
